(19) United States
(12) Patent Application Publication
(10) Pub. No.: US 2002/0120466 A1
(43) Pub. Date: Aug. 29, 2002

(54) System and method for determining and reporting data codes for medical billing to a third party payer

(75) Inventor: Sam Finn, Dallas, TX (US)

Correspondence Address: Michael L. Diaz, Michael L. Diaz, P.C., Suite 200, 555 Republic Drive, Plano, TX, 75074, US

(73) Assignee: Hospital Support Services, Ltd.

(21) Appl. No.: 09/795,381

(22) Filed: Feb. 26, 2001

(51) Int. Cl. G06F 17/60

(52) U.S. Cl. 705/2

(57) ABSTRACT

A method and system for defining and reporting accurate medical codes of a patient for medical billing to a third party payer. The system includes an input terminal for inputting patient data by a physician. The system also include a computing system which assists the physician in determining a correct standardized code for a medical procedure performed by the physician on the patient. The system also includes a means for determining the point value of the selected standardized code. The system also creates a report including the selected standardized code, total point value, and relevant patient data for the third party payer.

### BACKGROUND OF THE INVENTION

1. Technical Field of the Invention

This invention relates to medical coding and, more particularly, to a system and method for defining and reporting accurate medical codes for medical billing to a third party payer.

2. Description of Related Art

As is well known in the medical field, billing for insurance and Medicare and Medicaid can be both time consuming and complex. For example, Medicare requires that a code be assigned for each patient encounter, such as during the interaction between a physician and patient and is also used in determining corresponding diagnostic codes defining the patient's medical problem. A third party payer is an organization, carrier or intermediary that supplies insurance (including Medicare) or payment to individuals for medical care.

The American Medical Association in conjunction with the Health Care Financing Administration (HCFA) has developed a system of codes for the purpose of describing physician work for medical and surgical procedures, diagnostic tests, and other physician medical services rendered to patients. These codes are commonly known as Current Procedural Terminology (CPT) codes. The purpose of CPT codes are to provide a uniform language that accurately describes medical, surgical, and diagnostic services, and thereby serves as an effective means for reliable nationwide communication among physicians, patients, and third party payers.

The World Health Organization developed a similar method to identify medical diagnoses, conditions and injuries. These codes are International Classification of Diseases 9^{th} edition Clinical Modification (ICD9) codes.

Obviously, proper coding of surgical procedures is necessary to ensure proper billing to the insurance companies and MEDICARE/MEDICAID. However, these codes can be very complex. The CPT codes are currently further divided into CPT surgical codes, CPT anesthesia codes, evaluation and management codes, and radiological codes. Typically, a surgical procedure may actually consist of several procedures, each requiring a specific code. Each procedure code is assigned a number of relative value units (RVUs) which are used to determine the surgeon's cost of performing the procedure. The procedures performed by the surgeon are reported in descending order of RVUs. The surgeon is reimbursed according to the total number of RVUs. In the situation where a surgical procedure involves multiple CPT codes for the same operation, the coding can become particularly complex because certain add-on modifiers are attached. The actual reporting is done in descending order of RVUs, however, the actual reimbursement may be less since most codes subsequent to the first or primary code are discounted. In addition, some codes are exempt from being discounted, even though they may not have the highest point value.

To complicate matters further, anesthesiologists assisting in surgical procedures must report the surgical code used by the surgeon in the procedure, a corresponding anesthesia code (CPT anesthesia), as well as a corresponding ICD9 diagnosis code. The CPT anesthesia codes are assigned base points to determine the rate of reimbursement of the anesthesiologist. Also, when more than one code is utilized, only the highest value of any of the procedure codes is reported and used in the calculation of the anesthesiologist's fees. Additionally, anesthesiologists also must determine time points from the length of time of the procedure. The time points are added to the base points of the CPT surgical codes to calculate total points. The base points associated with the CPT anesthesia codes are reimbursed at the same rate as the time points, such that a more complex anesthesia code will have more base points to compensate the anesthesiologist for the greater complexity of the case. In order to be compliant with current federal laws, the anesthesiologist must use the same CPT surgical code as reported by the surgeon. When one CPT surgical code is appropriate for a particular procedure, there is a less likelihood of error or noncompliance (e.g., different codes being submitted by the surgeon and anesthesiologist). However, there is a tendency by an anesthesiologist to utilize a generic code (e.g., cholecystectomy vs. cholecystectomy with cholangiography), which both have the same base point value. In the situation where multiple CPT surgical codes are necessary, errors are more likely to occur.

In addition, coding is frequently accomplished by office personnel who are not intimately familiar with the procedure being perform, thus resulting in more errors in the coding process. Coding compliance has also taken on more significance with the Correct Coding Initiative (CCI) established by the HCFA. The CCI establishes significant penalties for incorrectly coding CPT surgical and anesthesia codes. Thus, in order to avoid violating federal statutes, it is imperative for physicians to properly code the surgical and associated anesthesia procedures. A system and method are needed which provides a simple and accurate process of reporting CPT surgical and anesthesia codes, as well as associated time points and any other miscellaneous points utilized in reports for third party payers.

Although there are no known prior art teachings of a solution to the aforementioned deficiency and shortcoming such as that disclosed herein, prior art references that discuss subject matter that bears some relation to matters discussed herein are U.S. Pat. No. 5,325,293 to Dorne (Dorne), U.S. Pat. No. 5,483,443 to Milstein et al. (Milstein), U.S. Pat. No. 5,809,476 to Ryan (Ryan), and U.S. Pat. No. 5,970,463 to Cave et al. (Cave).

Dorne discloses a method and system for correlating billing codes with planned or performed medical procedures. The method includes the steps of determining raw codes directly associated with all medical procedures performed or planned. Additionally, the method also generates a set of intermediate codes which account for the interrelation of the selected medical procedures without altering the raw codes. The method also generates a set of billing codes from the intermediate codes. Although Dorne discloses a method of correlating medical procedures with CPT codes, Dome does not teach or suggest generating timing points, speciality points, or associating the surgical procedures with ICD9 codes. Dorne suffers from the disadvantage of merely cross coding medical procedures with CPT codes, without including additional billing factors. In addition, Dorne does not teach or suggest correlating the CPT surgical codes with associated CPT anesthesia codes. Additionally, Dorne automatically selects the CPT codes from data provided by the physician, rather than the physician directly selecting the CPT codes. Also, Dorne only addresses correlating radiological procedures and does not teach or suggest utilizing the correlation for other fields, such as surgery or anesthesia.

Milstein discloses a process for calculating a CPT code from inputs received from a physician or other medical personnel. The physician is prompted with lists of choices corresponding to a patient's medical status. The physician makes selections from these lists which are inputted into a computer. The computer then generates intermediate codes from the physician's selections. After the physician has completed entering the selections, the computer then calculates a final CPT code for reimbursement purposes based on the previously calculated intermediate codes. Although Milstein discloses a method for calculating a CPT code and ICD9 codes associated with a particular medical procedure, Milstein does not teach or suggest a method providing timing points and speciality points to generate a billing report for a third party payer. In addition, Milstein merely discloses evaluation and management codes used primarily by internists or general practitioners. Milstein does not teach or suggest a system or method for use with surgical or anesthesia codes.

Ryan discloses a system for coding data which includes a computer program for analyzing text inputted to the computer. The input data is text describing a medical diagnosis and operation which would be dictated or recorded by a surgeon subsequent to an operation being performed on a patient. The coding system analyzes each word or term of the medical information in conjunction with specialized and generalized dictionaries of words and terms, along with relationships between individual words and terms. However, Ryan does not include calculating time points or other various specialty points used in computing billing reports for insurance companies. Ryan merely analyzes the text (either written or via voice), in order to determine a CPT code. Ryan does not utilize the direct intervention of a physician to correctly select the surgical and the corresponding anesthesia codes.

Cave discloses a medical claims analysis system and method which categorizes medical claims into episodes of care having predetermined diagnostic cluster types. The system analyzes medical claim items, some of which may have principal diagnosis codes, and some having non-principal, missing, or incorrect diagnosis codes. Patient treatment episodes (PTEs) are formed from the principal diagnosis codes, each PTE being of a particular diagnostic cluster type. The system categorizes non-principal-diagnostic claim items into the PTEs on the basis of temporal, physiological or clinical relations between the claims items and the PTEs However, Cave does not teach or suggest calculating time points or the specialty points used in computing billing reports for insurance companies. Cave merely discloses an analysis of codes based on statical utilization purposes.

Thus, it would be a distinct advantage to have a system and method which assists a physician in accurately determining the CPT surgical and corresponding anesthesia codes for third party payer reports. It is an object of the present invention to provide such a system and method.

### SUMMARY OF THE INVENTION

In one aspect, the present invention is a system for defining and reporting accurate medical codes of a patient for medical billing to a third party payer. The system includes an input terminal for receiving data describing a medical procedure of the patient and a computing system communicating with the input terminal. The computing system includes a code correlator for assisting a physician in selecting a specific code from a plurality of standardized codes. The specific code accurately describes the medical procedure performed by the physician. In addition, the computing system includes means for calculating the total points associated with said selected code and a report generator for compiling the inputted data, the selected codes, and calculated points into a report for the third party payer.

In another aspect, the present invention is a system for defining and reporting accurate medical codes of a patient for medical billing to a third party payer. The system includes a device for receiving data describing a medical procedure of the patient and a computing system communicating with device for receiving data. The computing system assists a physician in selecting a specific code from a plurality of standardized codes. The specific code accurately describes the medical procedure performed by the physician. The computing system also calculates the total points associated with the selected code and a report generator for compiling the data, selected code, and calculated points into a report for the third party payer.

In still another aspect, the present invention is a system for defining and reporting accurate medical codes of a patient for medical billing to a third party payer. The system includes an input terminal for receiving data describing a medical procedure of the patient and a computing system communicating with the input terminal. The computing system includes a code correlator for assisting an anesthesiologist assisting in the medical procedure in selecting a specific code from a plurality of standardized Current Procedural Terminology (CPT) surgical codes. The specific code accurately describing the medical procedure performed on the patient. In addition, the computing system associates a CPT anesthesia code with the specific CPT surgical code and calculates the total points associated with the selected code. A report generator compiles the data, selected codes, and calculated points into a report for the third party payer.

In another embodiment, the present invention is a method of defining and reporting accurate medical codes of a patient for medical billing to a third party payer. The method begins with a physician who performs a medical procedure on a patient, inputting data on the patient into an input terminal. Next, a computing system provides a plurality of medical descriptions describing medical procedures. The physician then selects a medical description accurately describing the medical procedure from the plurality of medical descriptions. The computing system then determines the correct code from the selected medical description and calculates a point value for the selected correct code. The computing system then generates a report providing the correct code, the point value of the medical procedure, and relevant data on the patient.

In still another aspect, the present invention is a method of defining and reporting accurate medical codes of a patient for medical billing to a third party payer. The method begins by an anesthesiologist who assists a surgeon performing a medical procedure on a patient, inputting data on the patient into an input terminal. Next, a computing system communicating with the input terminal provides a plurality of medical descriptions describing medical procedures to the anesthesiologist. The anesthesiologist then selects a medical description accurately describing the medical procedure performed on the patient from the plurality of medical descriptions. The computing system then determines the correct code from the selected medical description and determines a correct anesthesia code from the correct selected code. The computing system also calculates a point value for the determined correct code and generates a report providing the correct code, the point value of the medical procedure, and relevant data on the patient.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for determining and reporting accurate medical data codes to a third party payer in the preferred embodiment of the present invention;

FIGS. 2A-2D are flow charts outlining the steps for determining and reporting medical codes for medical billing to third party payers;

FIGS. 3A-3D are flow charts outlining the steps for determining and reporting medical codes and associated anesthesia codes for medical billing to third party payers;

FIG. 4 is a representation of a screen display illustrating a login procedure generated by the system in the preferred embodiment of the present invention;

FIG. 5 is a representation of a screen display illustrating a display for entry of patient data generated by the system in the preferred embodiment of the present invention;

FIG. 6 is a representation of a screen display illustrating an example of a menu selection of a surgical procedure according to the teachings of the present invention;

FIG. 7 is a representation of a screen display illustrating optional procedure data generated by the system in the preferred embodiment of the present invention;

FIG. 8 is a representation of a screen display illustrating a report illustrating a specific procedure performed on a specific patient generated by the system in the preferred embodiment of the present invention;

FIG. 9 is a representation of a screen display illustrating a report illustrating specific doctor information for a plurality of patients generated by the system in the preferred embodiment of the present invention;

FIG. 10 is a representation of a screen display illustrating a report illustrating a doctor group's information generated by the system in the preferred embodiment of the present invention; and

FIG. 11 is a report generated by the system suitable for filing to a third party payer in the preferred embodiment of the present invention.

### DETAILED DESCRIPTION OF EMBODIMENTS

The present invention is a system and method for determining and reporting accurate medical data codes for medical billing to a third party payer.

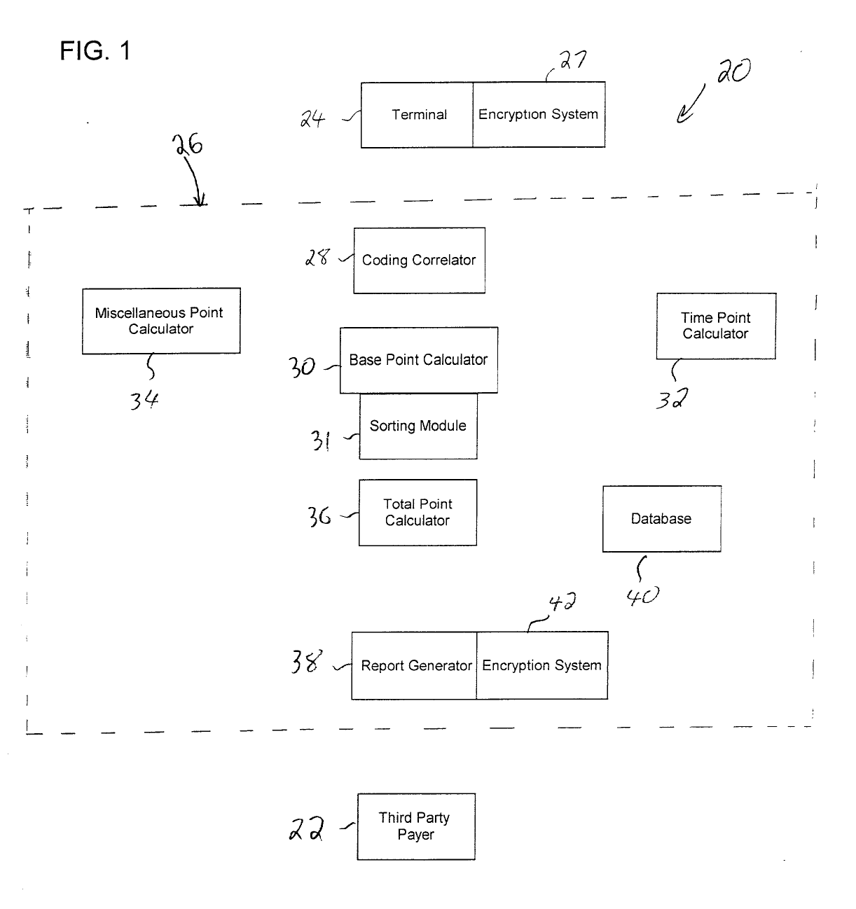

FIG. 1 is a simplified block diagram illustrating the components of a system 20 for determining and reporting accurate medical data codes to a third party payer 22 in the preferred embodiment of the present invention. The system includes an input terminal 24 communicating with a computer 26. The computer 26 includes a coding correlator 28, a base point calculator 30, a time point calculator 32, a miscellaneous point calculator 34, a total point calculator 36, and a report generator 38. In the preferred embodiment of the present invention, the components of the computer reside in one location. However, in alternate embodiments of the present invention, the various components may be located in separate computing systems.

The input terminal 24 may be any device which allows a physician or other medical staff to provide data to the computer 26. The terminal may include a keyboard, a touch screen, or voice recognition system. In one embodiment, the input terminal may be a conventional personal data assistant (PDA). The terminal may be wired directly to the computer 26 or communicate via wireless communications, which is well known in radio telecommunications systems. It must be understood, that any device may be used which can effective provide desired data to the computer 26. Additionally, the inputted data may be encrypted for secure transmission to the computer. The input terminal may include a terminal encryption system 27 to encrypt data prior to transmission.

In the preferred embodiment of the present invention, the computer 26 may be any conventional computer having the necessary computing power to store data within a database and provide calculations based on the stored data and inputted data.

The computer 26 also includes a database 40 which stores a plurality of data coding sets. In the preferred embodiment of the present invention, the database includes a full listing of CPT surgical and anesthesia codes. However, the database may include a partial list or a different coding scheme. Additionally, the database may include the ICD9 diagnostic codes associated with each CPT code.

The coding correlator 28 provides the physician the means for correctly determining the CPT and associated ICD9 codes. In the preferred embodiment of the present invention, the coding correlator provides a drop down menu divided categorically by selected field. The drop down menu provides a decision tree assisting the physician in determining the correct code. Once the physician selects the specific CPT code, the coding correlator determines the correct associated ICD9 code. In an alternate embodiment of the present invention, the coding correlator also provides the associated CPT anesthesia code derived from the CPT surgical code.

The base point calculator receives the correct CPT surgical and/or anesthesia codes and determines the RVUs or base points (for anesthesiologists) associated with the code. For anesthesia reimbursement, only the highest value for base points is counted. For example, where a procedure includes two CPT anesthesia codes (e.g., 00600 having 10 base points and 00670 having 13 base points), only the CPT anesthesia code with the highest base points is counted (e.g., 00670 with 13 points). Thus, the base point calculator automatically determines the CPT anesthesia with the highest point value.

For CPT surgical codes, there is no need to determine the codes with the highest RVUs, since all RVUs will be accounted in determining the reimbursement of the surgeon. The base point calculator may optionally include a sorting module 31 to sort the CPT codes in a descending order of RVUs. The sorting module may also allow the input of modifiers by the surgeon. Additionally, the sorting module will allow the incorporation of any other coding rules, such as those which may be implemented by the HCFA in the future. For example, secondary codes may be discounted. Modifiers may also change the value of the codes. Thus, the sorting module allows for the addition or revision of coding rules and the associated values of the medical procedures.

The physician or other medical staff may also optionally input the time expended on the procedure through the input terminal 24. For most procedures where Medicare is the third party payer 22, an anesthesiologist assisting a surgeon in a procedure must input the elapsed time of the procedure. The anesthesiologist thus can enter the time through a convenient menu system into the computer 26. The time point calculator 32 receives the relevant time data and determines the correct time points for the specified time. The time point calculator may not be required by the surgeon in inputting CPT surgical codes.

The system also optionally includes the miscellaneous point calculator 34. The miscellaneous point calculator is optional, and mostly utilized by anesthesiologists. The anesthesiologist can input qualifying or special circumstances which increases the overall point value for the procedure. For example, an anesthesiologist may be allotted additional points for procedures involving patients over a specific age. The anesthesiologist is presented with a menu providing options which the physician can select to include with the procedure. This inputted data is communicated to the miscellaneous point calculator to calculate the miscellaneous points of the special circumstances.

The total point calculator 36 receives point values from the base point calculator 30, the time point calculator 32, and the miscellaneous point calculator 34. The total point calculator then determines the total point value for the inputted procedure. This total point value is sent to the report generator 38.

The report generator 38 receives the total point value and compiles the various CPT surgical and/or anesthesia codes. Additionally, patient information, entered by the physician at the time of data entry is also compiled. The received data is compiled into a report useable by the third party payer. The third party payer may be any entity paying for all or a portion of the medical bills of a patient, such as Medicare, an insurance company, or Medicaid. The report generator may also be optionally linked to the physician's billing software program, so that information inputted by the physician is also inputting into the office's accounting.

The report generator 38 can also optionally encrypt any data through an encryption system 42 located within the computer 26. Due to privacy concerns for a patient, the report generated by the report generator may first be encrypted prior to transmission to the third party payer 22. The third party payer can translate the encrypted data through a key for deciphering the encrypted data utilizing deciphering techniques well known in the secure data transmission industry.

The system 20 allows a physician or other medical staff to properly and accurately determine the correct CPT codes (surgical or anesthesia). The accurateness of the selection of codes is accomplished by querying the surgeon directly or indirectly. If the surgeon is attempting to determine the correct code, the system 20 provides a list of possible CPT codes which may be used, based on the description inputted into the coding correlator 28. Although the coding correlator provides several code selections, it is the surgeon who must properly select the correct CPT code. In other situations, where an anesthesiologist is utilizing the system 20, the anesthesiologist must query the surgeon for the correct code. If necessary, the coding correlator provides codes which might be used in assisting the surgeon in determining the correct CPT codes. Once the proper CPT code is selected, the coding correlator can provide a corresponding CPT anesthesia code. Additionally, the coding correlator provides the associated ICD9 diagnostic code.

The system 20 also allows the inclusion of time points and any additional miscellaneous points within a report generated by the report generator 38. The time points are easily calculated by a menu providing input of start and stop times of the surgical procedure. Additionally, in the situation where the anesthesiologist is utilizing the system, additional miscellaneous points are inputted via a menu system.

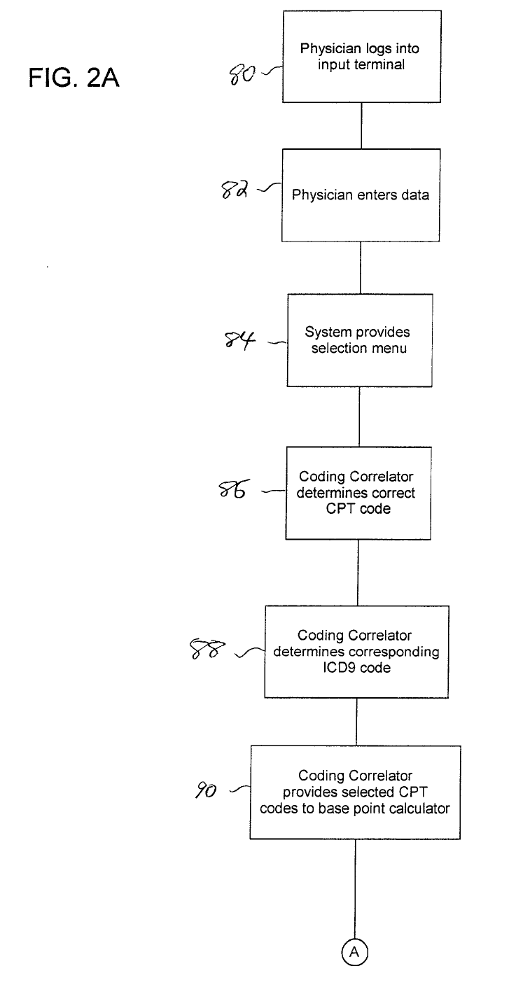

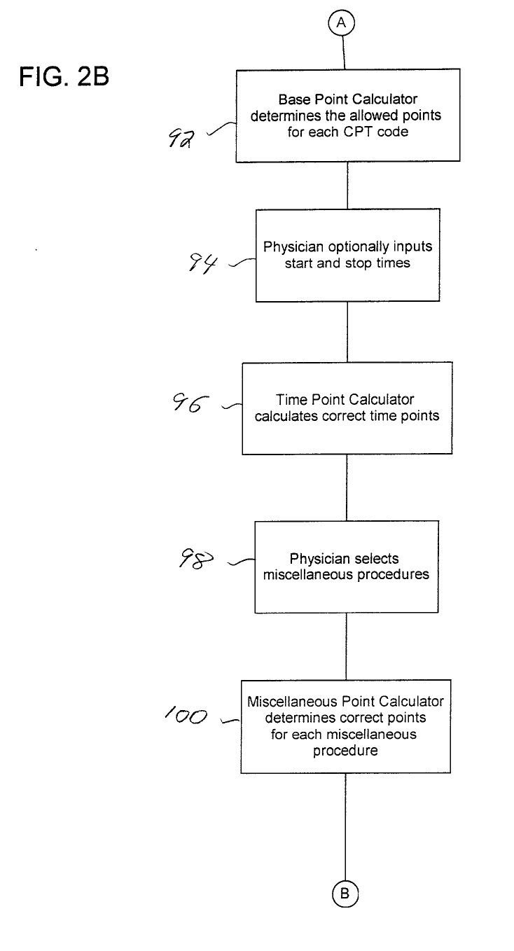

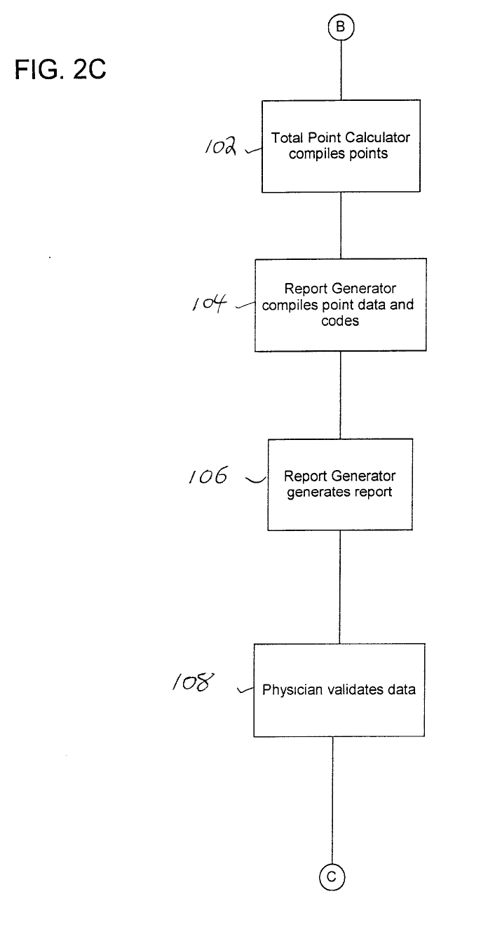

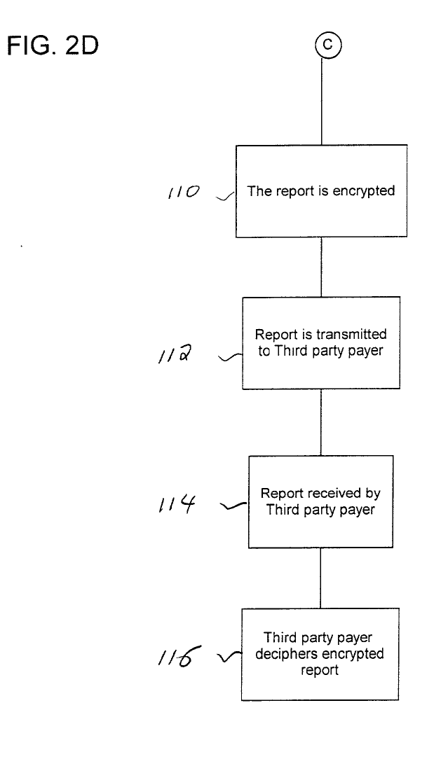

FIGS. 2A-2D are flow charts outlining the steps for determining and reporting medical codes for medical billing to third party payers. With reference to FIGS. 1, 2A, 2B, 2C, and 2D, the steps of the method will now be explained. The method begins with step 80 where a physician, such as a surgeon, logs onto the input terminal. In the preferred embodiment of the present invention, for further security, all data is encrypted. On initial login by the physician, the system 20 may include a public key interface allowing encryption and decryption of all data compiled within the system 20. Preferably, entry into the system 20 also requires the use of a user name and password to provide security and privacy of patients' medical histories. In the preferred embodiment of the present invention, since data may be conveniently entered within the general vicinity of the operating room immediately following the procedure, the surgeon performing the surgical procedure inputs the data. However, in alternate embodiments of the present invention, other medical staff may enter the data. Correct entry of the password allows access to only those patients for whom the physician is authorized access to the patient's records. Next, in step 82, the physician enters the patient data. For example, on initial patient data entry, a list of questions are provided such as patient name, address, sex, and age. However, on follow up procedures, the physician need only input the patient name to correctly select the specified patient.

The method then moves to step 84, where the system 20 provides a series of questions or menus assisting the physician in correctly determining the correct CPT surgical codes. If the physician already knows the correct CPT surgical code, the physician may enter the code directly. However, if the physician requires assistance in determining the code, the system provides the menu of items for narrowing the choices of codes. For example, a drop down menu may provide a list of body parts for which a procedure may have been performed on (e.g., ear, nose, sinuses, larynx, trachea). After selecting the correct body part, the menu may provide generic types of procedures which may be associated with the body part. The physician can then select the generic types of procedures, which further provides a list of procedures. From this list of procedures, the physician finds and selects the correct CPT surgical code. Additionally, the system 20 includes the database 40 having an expanded list of CPT surgical codes which the physician can manually research. Once the correct CPT codes are selected, the physician may also input modifiers for each code.

The system 20 thus utilizes the knowledge of the physician to assist the physician in selecting the correct CPT code. Additionally, unlike other cross coding systems, the physician actually selects the correct CPT surgical codes through the assistance of the system 20, not having the system selecting the code without the direct invention of the physician.

Next, in step 86, the coding correlator 28 determines the correct CPT surgical code from the surgical procedure which the physician has selected. Additionally, in step 88, the coding correlator determines the corresponding ICD9 code associated with the CPT surgical code. The physician may also manually enter an ICD9 code. Additionally, for reference by the physician, the system 20 also provides an expanded ICD9 look up table of all ICD9 codes. The list of all CPT codes, including IC9D codes may be automatically updated, such as through a download via the Internet or a software update (e.g., CD/floppy disk) provided for the system 20. Currently, the codes are amended annually by the governing organizations of the codes. The system 20 may include an interface with the governing organizations to obtain a list of current and modified codes, thus ensuring accurate coding.

In step 90, the coding correlator 28 provides the selected CPT codes to the base point calculator 30. In step 92, the base point calculator determines the allowed RVU for each CPT code, to include any modifiers supplied by the physician.

The physician can also optionally input start and stop times of the procedure in step 94. In step 96, the time point calculator 32 calculates the correct time points associated with the start and stop times of the procedure.

In step 98, the physician optionally selects any miscellaneous procedures or qualifying/special circumstances which may be used during the surgical procedure. The system 20 provides a list of qualifying/special circumstances which allow for inclusion of additional points. In step 100, the miscellaneous point calculator 34 determines the correct points allocated for each qualifying/special circumstance. Next, in step 102, the total point calculator compiles the points from the base point calculator 30 utilizing any coding rules determined by the coding module 31. Additionally, the total point calculator may also optionally add points determined from the time point calculator 32 and the miscellaneous point calculator 34 to provide a total point assessment for the procedure.

In step 104, the report generator 38 compiles the point data including the total point assessment from the total point calculator 36 and the codes from the coding correlator 28. Next, in step 106, the report generator generates a report listing the selected codes, the calculated points, patient data, and any other relevant data needed by the third party payer 22. Several different types of reports may be derived from the data. One report may provide information required by the third party payer. Another report may include administrative data of past procedures performed on a particular patient. In addition, other reports may provide specific data on procedures performed by a particular physician. Additional, by inputting data on each patient, demographic information on the patients may be determined. All this information may be provided to office administration personnel or other parties.

In step 108, the physician may optionally validate the data by reviewing the data and accepting the data. The system can provide the report for review by the physician and provide a means for editing the results or accepting the report. When the physician accepts the report, the system 20 can optionally prevent further revisions. In an alternate embodiment, revisions can still be made on the report, however, the original report is saved. The saved original report allows audits of past reports by the physician's office, or by the third party payer.

In step 110, the report is optionally encrypted by the encryption system 42. Next, in step 1 2, the report is optionally transmitted to the third party payer. Additionally, the report, or any relevant data may be sent to the administrative section of the physician's office. The report may be formatted in such a fashion as to provide a simple interface with the office's medical billing program. The report may also be electronically transmitted or printed and sent via mail or facsimile. The transmission of data may include transmission via the Internet. In step 114, the report is received by the third party payer. In step 116, if the report is encrypted, the third party payer deciphers the encrypted report utilizing a key. The encryption/decipher techniques are well known in the art of secure data transmission systems.

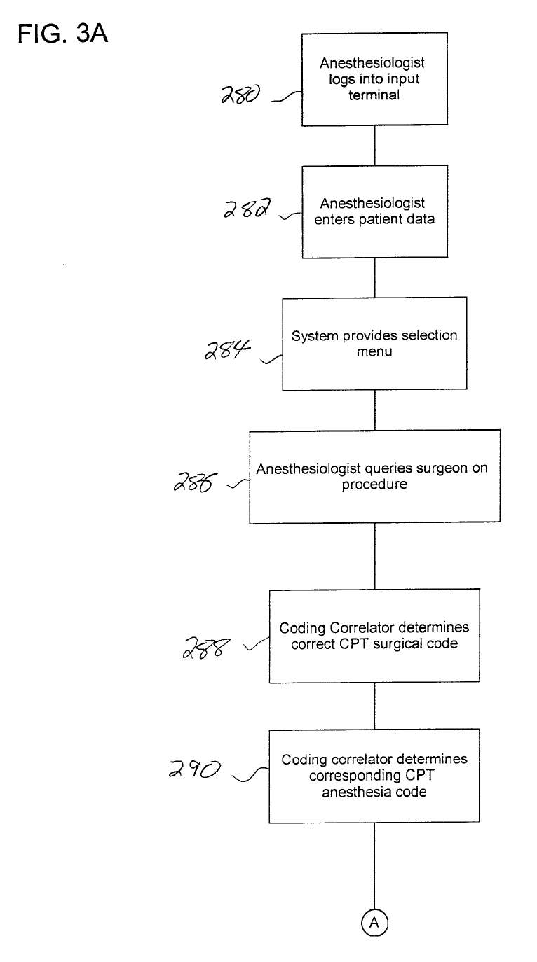

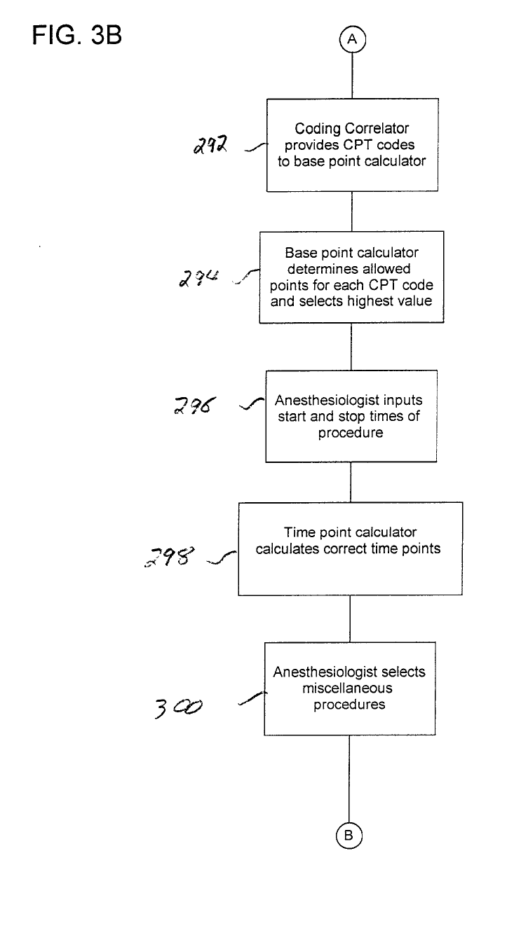

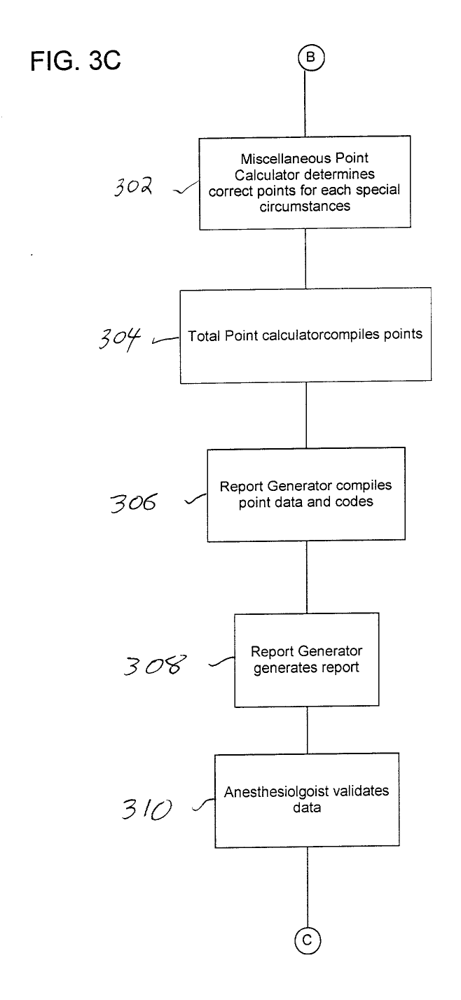

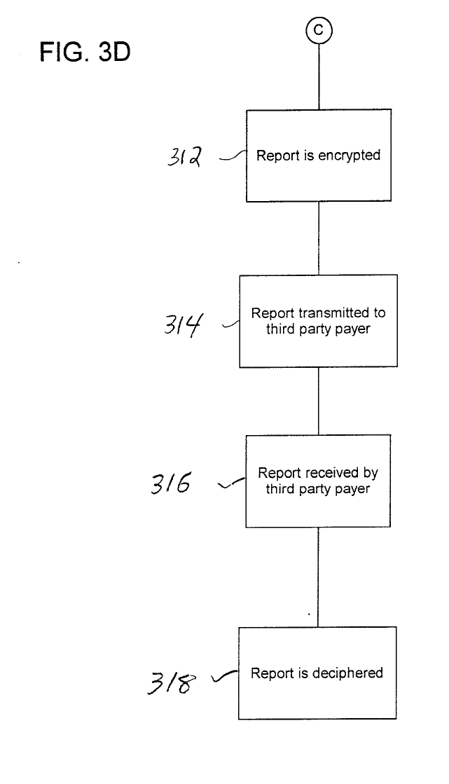

FIGS. 3A-3D are flow charts outlining the steps for determining and reporting medical codes and associated anesthesia codes for medical billing to third party payers. With reference to FIGS. 1, 3A and 3B, the steps of the method will now be explained. The method begins with step 280 where an anesthesiologist logs onto the input terminal 24. In the preferred embodiment of the present invention, the anesthesiologist must enter a user name and proper password to gain access to the system 20. The use of a password and user name provides security and privacy of patients' medical histories. On initial login by the physician, the system 20 may also include a public key interface allowing encryption and decryption of all data compiled within the system 20. In the preferred embodiment of the present invention, the anesthesiologist assisting a surgeon in the surgical procedure inputs the data into the input terminal 24. However, in alternate embodiments of the present invention, other medical staff may enter the data. Correct entry of the password allows access to only those patients for whom the anesthesiologist is authorized to access the patient's records. Next, in step 282, the anesthesiologist enters the patient data. For example, on initial patient data entry, a list of questions are provided such as patient name, address, sex, and age. However, on follow up procedures where initial patient information has been entered, the anesthesiologist need only input the patient name to correctly select the specified patient.

Next, in step 284, the system 20 provides a series of questions or menus allowing the anesthesiologist to properly select the correct CPT surgical anesthesia codes. If the anesthesiologist already knows the correct CPT surgical code, the anesthesiologist may enter the code directly. However, if the anesthesiologist requires assistance in determining the code, the system provides the menu of items for narrowing the choices of codes. For example, a drop down menu may provide a list of body parts for which a procedure may have been performed on, such as ear, nose, sinuses, larynx, trachea. After selecting the correct body part, the menu may provide generic types of procedures which may be associated with the body part. The anesthesiologist can then select the generic types of procedures, which further provides a list of procedures. From this list of procedures, the anesthesiologist finds the correct CPT surgical code. Additionally, the system 20 includes the database 40 having an expanded list of CPT surgical codes which the physician can research. The list of all CPT codes, including IC9D codes may be automatically updated, such as through a download via the Internet or a software update (e.g., CD/floppy disk) provided for the system 20. Currently, the codes are amended annually by the governing organizations of the codes. The system 20 may include an interface with the governing organizations to obtain a list of current and modified codes, thus ensuring accurate coding.

In step 286, however, in the preferred embodiment, the anesthesiologist asks the surgeon for the procedure and, optionally, the CPT code. In this fashion, both the anesthesiologist and the surgeon provide a third party payer with the identical CPT surgical codes, which is now required for correct compliance with the Correct Coding Initiative of the HCFA.

The system 20 thus utilizes the knowledge of the anesthesiologist, with direct querying of the surgeon for correct and identical code reporting, to assist the anesthesiologist in selecting the correct CPT code. Additionally, unlike other cross coding systems, the anesthesiologist actually selects the correct CPT surgical codes with the assistance of the system 20, rather than the system selecting the codes with only limited input from the physician.

The system then moves to step 288, where the coding correlator 28 determines the correct CPT surgical code from the surgical procedure which the anesthesiologist has selected. Additionally, in step 290, the coding correlator determines the corresponding CPT anesthesia code and ICD9 code associated with the CPT surgical code. The anesthesiologist may also manually enter a CPT anesthesia and/or ICD9 code. The system 20 also optionally provides an expanded ICD9 and CPT anesthesia code look up table of all possible codes.

In step 292, the coding correlator 28 provides the selected CPT codes to the base point calculator 30. In step 294, the base point calculator determines the allowed points for each CPT code and selects the CPT code with the highest point value. For example, where a procedure includes two CPT anesthesia codes (e.g., 00600 having 10 base points and 00670 having 13 base points), only the CPT anesthesia code with the highest base points is counted (e.g., 00670 with 13 points). Thus, the base point calculator automatically determines the CPT anesthesia with the highest point value.

In regards to the assistance that an anesthesiologist provides to a surgeon, it is common for additional points to be allotted based on the time elapsed on the surgical procedure. Thus, the anesthesiologist can also optionally input start and stop times of the procedure in step 296. In step 298, the time point calculator 32 calculates the correct time points associated with the start and stop times of the procedure.

In step 300, the anesthesiologist selects any miscellaneous procedures or special circumstances which may be used during the surgical procedure. The system 20 provides a list of special/qualifying circumstances which provide for inclusion of additional points. For example, additional points may be allocated for an elderly patient. In step 302, the miscellaneous point calculator 34 determines the correct points allocated for each special circumstance. Next, in step 304, the total point calculator compiles the points from the base point calculator 30, the time point calculator 32, and the miscellaneous point calculator 34 to provide a total point assessment for the surgical procedure.

In step 306, the report generator 38 compiles the point data including the total point assessment from the total point calculator 36 and the codes from the coding correlator 28. Next, in step 308, the report generator generates a report listing the selected codes, the calculated points, patient data, and any other relevant data needed by the third party payer 22. Several different types of reports may be derived from the data. One report may provide information required by the third party payer. Another report may include administrative data of past procedures performed on a particular patient. In addition, other reports may provide specific data on procedures performed by a particular physician. Additionally, by inputting data on each patient, demographic information on the patients may be determined.

In step 310, the anesthesiologist may optionally validate the data by reviewing the data and accepting the data. The system can provide the report for review by the anesthesiologist and provide a means for editing the results or accepting the report. When the anesthesiologist accepts the report, the system 20 can optionally prevent further revisions. In an alternate embodiment of the present invention, revisions can still be made on the report, however, the original report is saved. The saved original report allows audits of past reports by the physician's office, or by the third party payer.

In step 312, the report is optionally encrypted by the encryption system 42. Next, in step 314, the report is optionally transmitted to the third party payer. Additionally, the report, or any relevant data may be sent to the administrative section of the physician's office. The report may be formatted in such a fashion as to provide a simple interface with the office's medical billing program. The report may also be electronically transmitted or printed and sent via mail or facsimile. Additionally, the report or any relevant data may be transmitted via the Internet. In step 316, the report is received by the third party payer. In step 318, if the report is encrypted, the third party payer deciphers the encrypted report utilizing a key. The encryption/decipher techniques are well known in the art of secure data transmission systems.

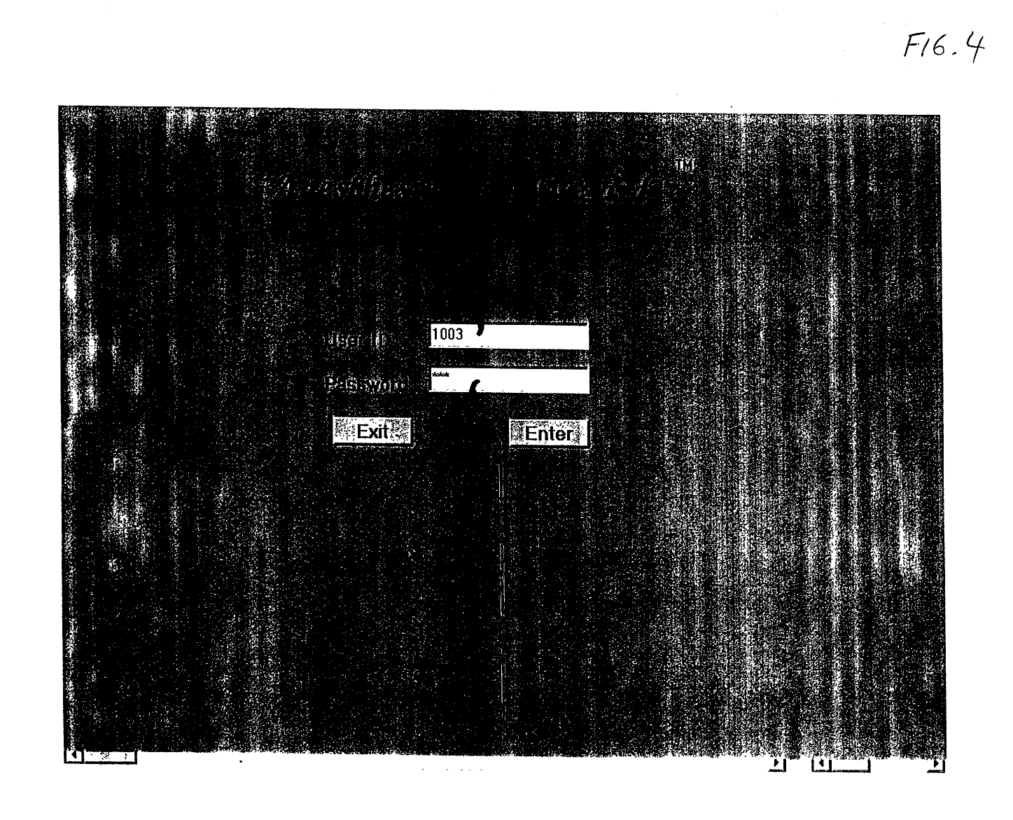

FIG. 4 is a representation of a screen display illustrating a login procedure generated by the system 20 in the preferred embodiment of the present invention. As illustrated, the physician may log onto the system 20 by providing a user ID 402 and password 404.

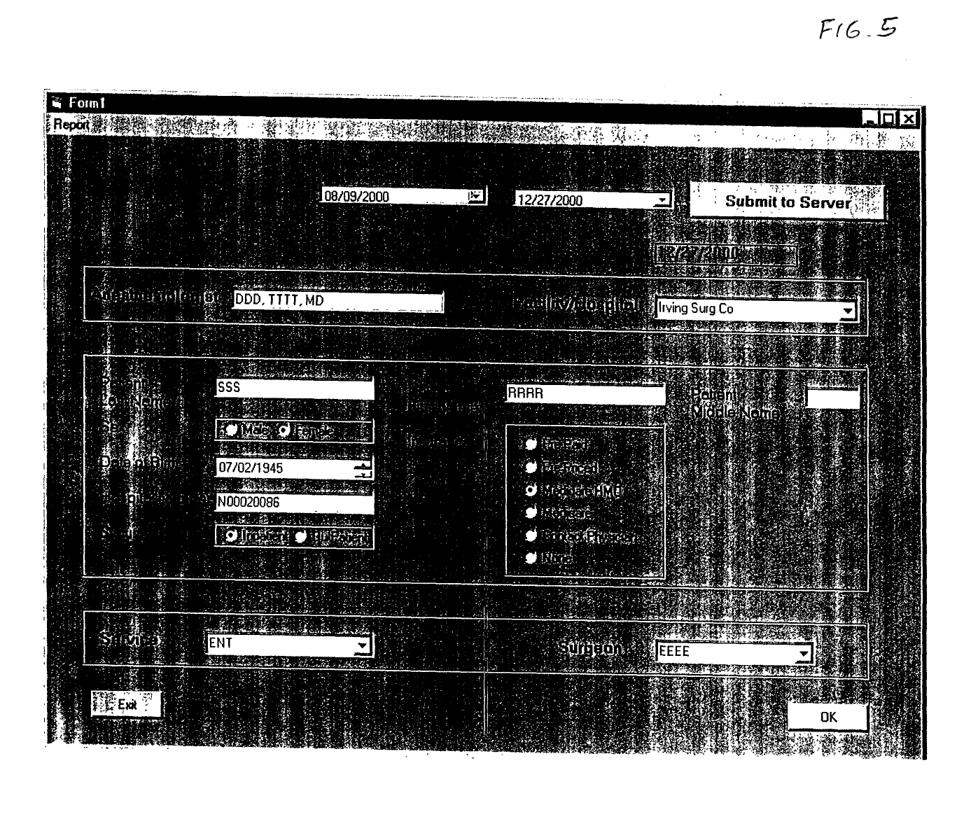

FIG. 5 is a representation of a screen display illustrating a display for entry of patient data generated by the system 20 in the preferred embodiment of the present invention. In the preferred embodiment of the present invention, the patient's name, sex, date of birth, hospital identification number, patient status, and third party payer information may be inputted. Additionally, other information such as the surgeons or other medical staff attending during the procedure may be included. Although FIG. 5 illustrates some types of information of the patient, the system is not limited to the illustrated data queries. Other information queries may be utilized depending on the desires of the levels of information necessary on each patient.

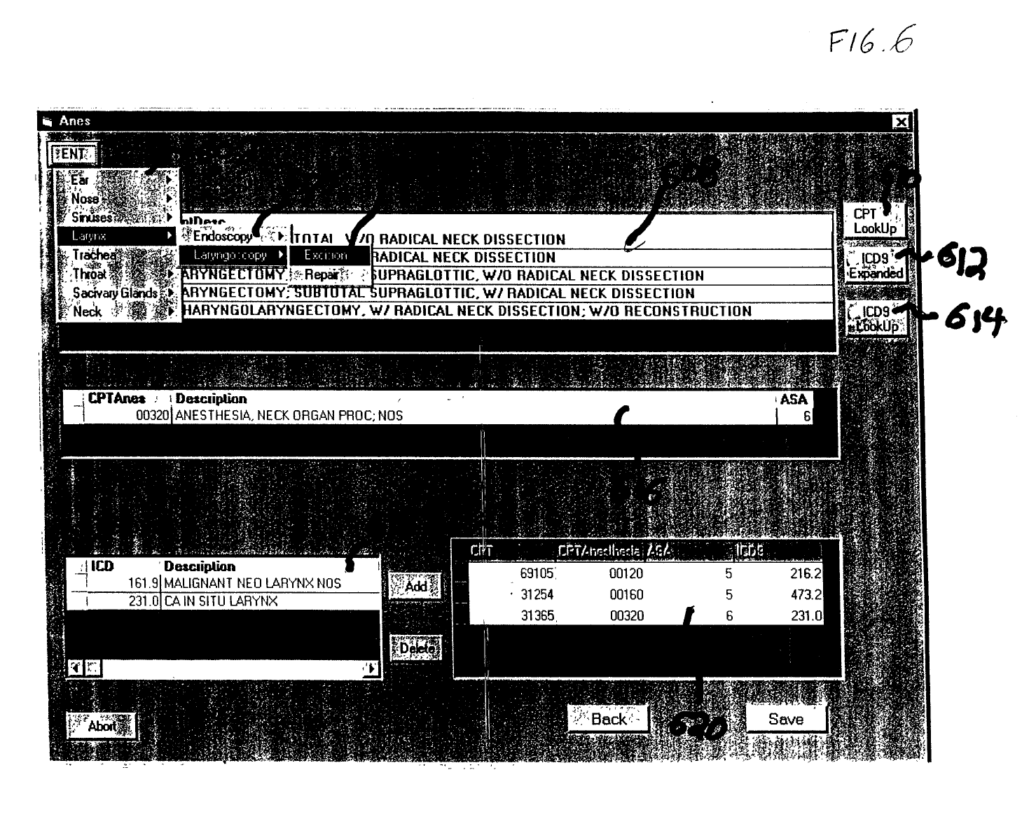

FIG. 6 is a representation of a screen display illustrating an example of a menu selection of a surgical procedure of steps 84 or 284 according to the teachings of the present invention. In the example depicted in FIG. 6, a prior selection menu 602 divides the possible body parts for which surgical procedures may be performed. A secondary menu selection 604 provides a listing of possible generic procedure options. A tertiary menu 606 provides more specific procedure options of the selected generic procedure of menu selection 604. Once a procedure option is selected from menu 606, the system 20 provides a listing 608 of possible CPT surgical codes. Additional, a CPT lookup option 610 is available for full CPT surgical code listings. Additionally, a ICD9 expanded list option 612 and ICD9 lookup table 614 are provided for further listings of ICD9 codes. Once a CPT surgical code is selected from listing 608, a CPT anesthesia code 616 is generated from the corresponding CPT surgical code.

Still referring to FIG. 6, with the selection from the listing 608, a ICD9 diagnostic code 618 is generated. The system 20 allows multiple selections of CPT codes. A summary box 620 displays the selected CPT surgical and anesthesia codes, as well as the ICD9 codes and the points allocated for each code.

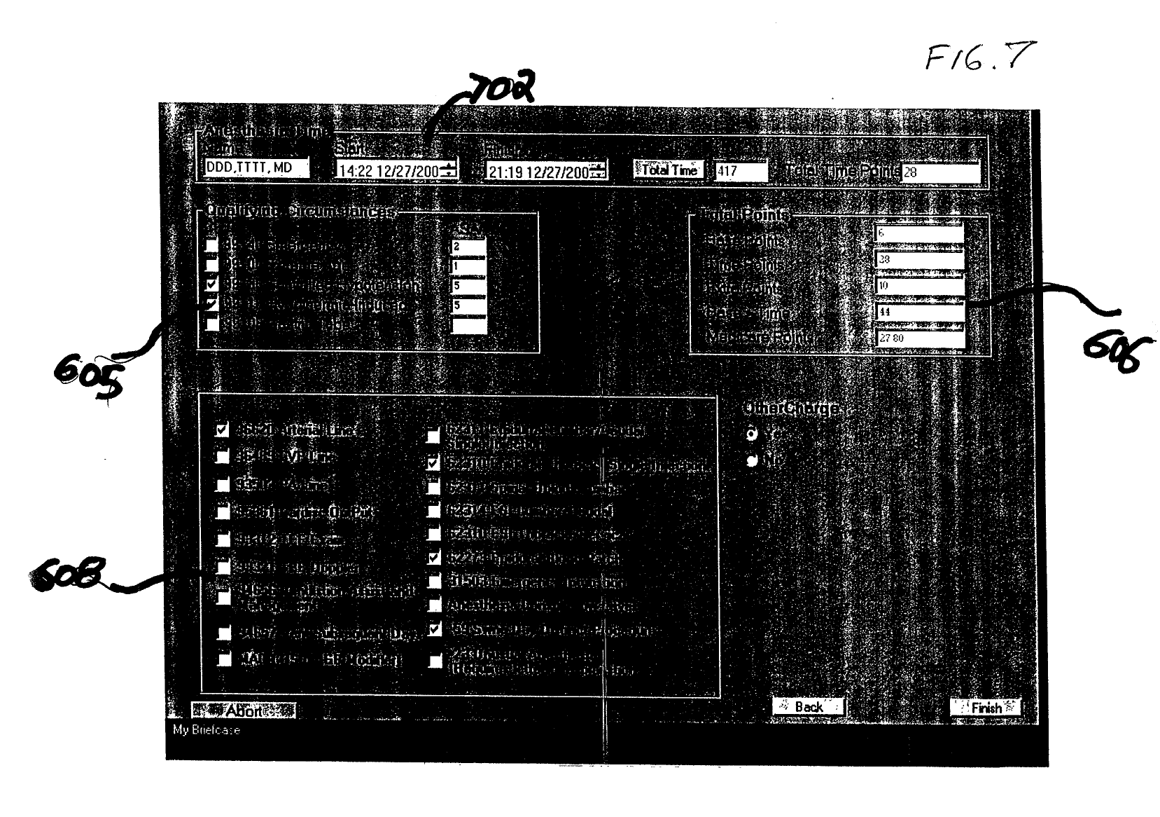

FIG. 7 is a representation of a screen display illustrating optional procedure data generated by the system 20 in the preferred embodiment of the present invention. The anesthesia start and stop time may be entered in the anesthesia time selection area 702. A total time and total time points allocated is generated by the system 20. Additionally, a qualifying circumstance display 605 provides selection of a qualifying circumstance which may generate additional points. A total point display 606 is also provided, which displays the accumulated total and breakdown of points. In addition, an additional procedure section 608 provides additional procedures performed by the physician.

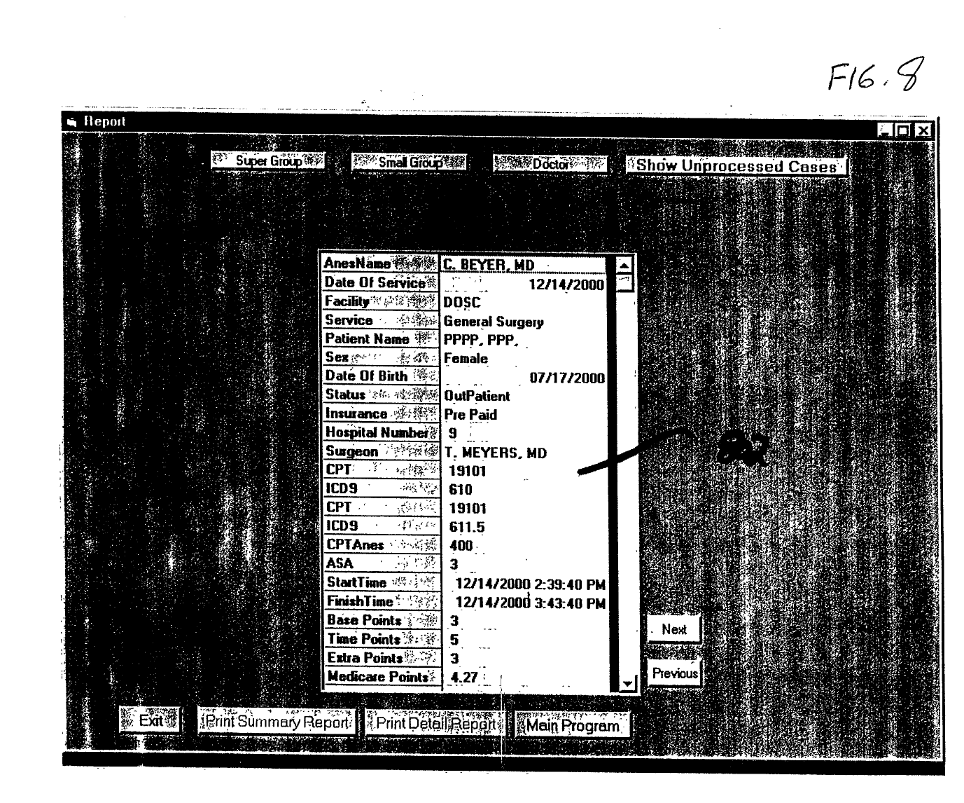

FIG. 8 is a representation of a screen display illustrating a report illustrating a specific procedure performed on a specific patient generated by the system 20 in the preferred embodiment of the present invention. FIG. 8 illustrates a screen display of a report 802 showing patient data including the patient's name, point total, and selected codes.

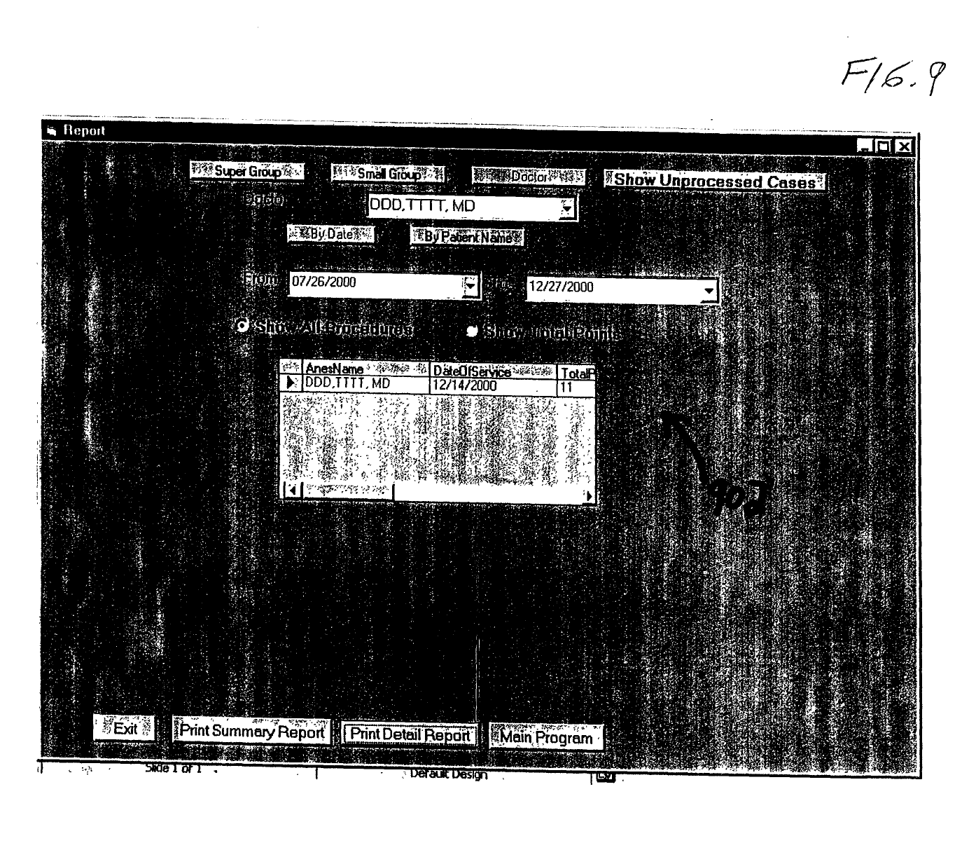

FIG. 9 is a representation of a screen display illustrating a report 902 illustrating specific doctor information for a plurality of patients generated by the system 20 in the preferred embodiment of the present invention. The system 20 can generate other types of data accumulated from the data inputted by the physician. For example, specific points accumulated by a particular doctor on a particular data or string of days may also be generated.

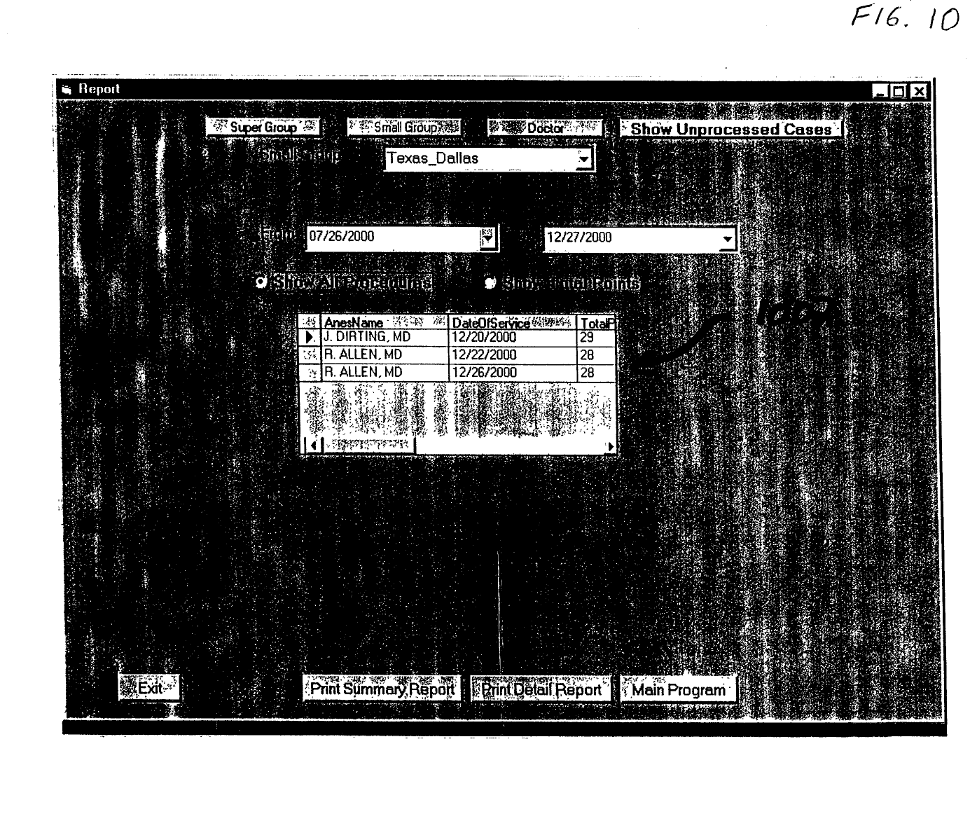

FIG. 10 is a representation of a screen display illustrating a report 1002 illustrating a doctor group's information generated by the system 20 in the preferred embodiment of the present invention. Additionally information which may be displayed includes specific data on a group of doctors for a specific day or days.

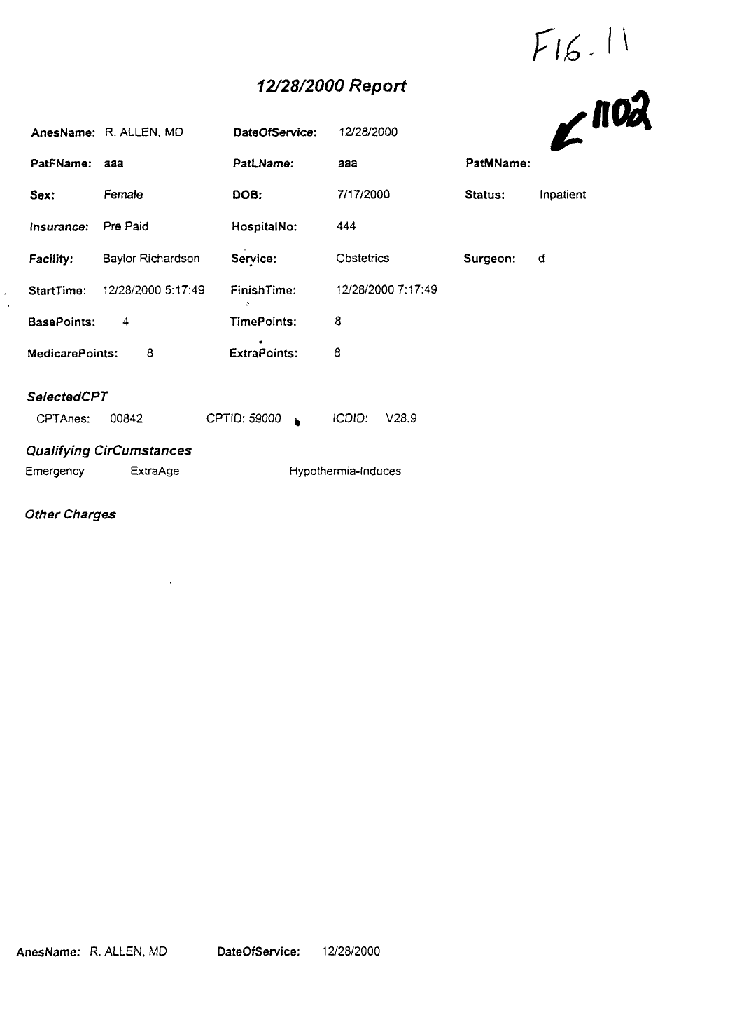

FIG. 11 is a report 1102 generated by the system 20 suitable for filing to a third party payer 22 in the preferred embodiment of the present invention. The report 1102 may be formatted to display all relevant data required by the third party payer 22.

FIGS. 4-11 merely exemplify possible display menus and reports which may be generated by the system 20. It should be understood that other embodiments can be utilized in displaying data input and output.

The present invention provides many advantages over existing art. With the advent of the Correct Coding Initiative, in order to avoid violating federal statutes, it is imperative that physicians provide accurate CPT codes to third party payers. The present invention insures that the correct codes are selected. By providing the tools for proper and convenient coding to the physician at the time immediately following the procedure, a more accurate and immediate coding of the procedure is possible. If a physician alone is utilizing the system 20, the system 20 provides the physician a menu selection which allows the proper selection by the physician to select the correct CPT codes. Additionally, if the system 20 is used by an anesthesiologist, the system 20 provides a methodology for the anesthesiologist to receive the correct code by querying the surgeon of the surgical procedure. This process insures that identical codes are reported by the surgeon and the anesthesiologist.

The system 20 also provides for multiple selection of CPT codes which automatically selects the procedure with the highest number of points. Additionally, the system 20 automatically determines the correct ICD9 codes as well as the corresponding CPT anesthesia codes. The system 20 also allows entry of additional items necessary for reporting to third party payers, such as time allocation and qualifying circumstances.

The system 20 allows the selection of the proper codes at the time of the procedure, which eliminates the risk of a physician forgetting which procedure was performed. Obviously, the best time for coding by a physician is immediately after the accomplishment of the procedure. The system allows a convenient method of immediately entering the necessary data. Since the physician is actually entering the data, an administrative assistant is no longer needed, which reduces third party errors and labor costs. In addition, by having the physician immediately enter the data for coding determination, billing to third party payers can be accomplished sooner. Overall, the system 20 provides accurate, timely code selection and report generation in an economical and efficient manner not available with existing systems. The system 20 is also may be customized for each physician or group of physicians to include names of the physicians, type of medical procedures (e.g., surgical, anesthesia, etc.), and specialized circumstances requiring specific entries.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for defining and reporting accurate medical codes of a patient for medical billing to a third party payer, the system comprising:
an input terminal for receiving data describing a medical procedure of the patient; and
a computing system communicating with said input terminal comprising:
a code correlator for assisting a physician in selecting a specific code from a plurality of standardized codes, said specific code accurately describing the medical procedure performed by the physician;
means for calculating the total points associated with said selected code; and
a report generator for compiling said data, selected codes, and calculated points into a report for said third party payer.

2. The system of claim 1 wherein said input terminal is a computer terminal.

3. The system of claim 1 wherein said input terminal is a personal data assistant (PDA).

4. The system of claim 1 wherein said input terminal is connected directly to said computing system.

5. The system of claim 1 wherein said input terminal communicates via a radio telecommunications system with said computing system.

6. The system of claim 1 further comprising a database of a plurality of standard codes describing a plurality of medical procedures.

7. The system of claim 6 wherein said standard codes include Current Procedural Terminology (CPT) codes.

8. The system of claim 7 wherein said standard codes include International Classification of Diseases 9th edition Clinical Modification (ICD9) codes associated with the CPT codes.

9. The system of claim 1 wherein said computing system includes means for calculating time points from a start time and a stop time of said medical procedure.

10. The system of claim 1 wherein said computing system includes means for calculating miscellaneous points from special circumstances performed during the medical procedure.

11. The system of claim 1 wherein said standardized codes include Current Procedural Terminology (CPT) codes.

12. The system of claim 11 wherein said standardized codes include International Classification of Diseases 9^{th} edition Clinical Modification (ICD9) codes associated with the CPT codes.

13. The system of claim 11 wherein said CPT codes are CPT surgical codes and include CPT anesthesia codes associated with the CPT surgical codes.

14. The system of claim 1 wherein said physician selects a plurality of selected codes associated with the medical procedure and further comprises means for automatically determining the selected code from said plurality of selected codes having the highest point value.

15. The system of claim 1 further comprising means for transmitting said report to said third party payer.

16. The system of claim 1 further comprising means for encrypting said data from said input terminal to said computing system.

17. The system of claim 1 further comprising means for encrypting said data from said report generator to said third party payer.

18. The system of claim 1 further comprising means for preventing revision of said selected code by said physician after said physician validates the inputted data and selected code.

19. The system of claim 1 wherein:
said plurality of standardized codes are Current Procedural Terminology (CPT) surgical and anesthesia codes; and
said code correlator determines a CPT anesthesia code from a selected CPT surgical code.

20. A system for defining and reporting accurate medical codes of a patient for medical billing to a third party payer, the system comprising:
means for receiving data describing a medical procedure of the patient; and
a computing system communicating with said means for receiving data comprising:
means for assisting a physician in selecting a specific code from a plurality of standardized codes, said specific code accurately describing the medical procedure performed by the physician;
means for calculating the total points associated with said selected code; and
a report generator for compiling said data, selected code, and calculated points into a report for said third party payer.

21. The system of claim 20 wherein said means for receiving data is a computer terminal.

22. The system of claim 20 wherein said means for receiving data is a personal data assistant (PDA).

23. The system of claim 22 wherein PDA communicates via a radio telecommunications system with said computing system.

24. The system of claim 20 further comprising means for calculating time points from a start time and a stop time of the medical procedure.

25. The system of claim 20 further comprising means for calculating miscellaneous points from a special circumstance performed during the medical procedure.

26. The system of claim 20 wherein said standardized codes include Current Procedural Terminology (CPT) codes.

27. The system of claim 26 wherein said standardized codes include International Classification of Diseases 9^{th} edition Clinical Modification (ICD9) codes associated with the CPT codes.

28. The system of claim 26 wherein said CPT codes are CPT surgical codes and include CPT anesthesia codes associated with the CPT surgical codes.

29. The system of claim 20 wherein said physician selects a plurality of standardized codes associated with the medical procedure and further comprises means for automatically determining the specific code from said plurality of selected codes having the highest point value.

30. The system of claim 20 further comprising means for transmitting said report to said third party payer.

31. The system of claim 30 further comprising means for encrypting said report when transmitting said report to said third party payer.

32. The system of claim 20 further comprising means for updating the computing system with modified codes for the plurality of standardized codes.

33. The system of claim 20 further comprising means for interfacing said report to a medical billing program of the physician.

34. A system for defining and reporting accurate medical codes of a patient for medical billing to a third party payer, the system comprising:
an input terminal for receiving data describing a medical procedure of the patient; and
a computing system communicating with said input terminal comprising:
a code correlator for assisting a anesthesiologist assisting in the medical procedure in selecting a specific code from a plurality of standardized Current Procedural Terminology (CPT) surgical codes, said specific code accurately describing the medical procedure performed on the patient;
means for associating a CPT anesthesia code with the specific CPT surgical code;
means for calculating the total points associated with said selected code; and
a report generator for compiling said data, selected codes, and calculated points into a report for said third party payer.

35. A method of defining and reporting accurate medical codes of a patient for medical billing to a third party payer, said method comprising the steps of:
inputting, by a physician performing a medical procedure on a patient, data on the patient into an input terminal;
providing, by a computing system communicating with the internal terminal, a plurality of medical descriptions describing medical procedures;
selecting, by the physician, a medical description accurately describing said medical procedure from said plurality of medical descriptions;
determining, by the computing system, the correct code from said selected medical description;
calculating, by the computing system, a point value for the selected correct code; and
generating, by the computing system, a report providing the correct code, the point value of the medical procedure, and relevant data on the patient.

36. The method of claim 35 wherein the step of providing a plurality of medical descriptions describing medical procedures includes providing a menu selection for assisting in selecting the correct medical procedure performed by the physician.

37. The method of claim 35 further comprising, before the step of determining, by the computing system, the correct code from said selected medical description, the steps of:
inputting, by the physician, a start time and a stop time of the medical procedure performed on the patient; and
calculating, by the computing system, time points associated with the start and stop times of the medical procedure.

38. The method of claim 37 wherein the step of calculating, by the computing system, a point value for the determined correct code includes adding the time points to the point value of the selected correct code.

39. The method of claim 35 further comprising, before the step of determining, by the computing system, the correct code from said selected medical description, the steps of:
inputting, by the physician, a miscellaneous procedure associated with said medical procedure performed on the patient; and
calculating, by the computing system, additional points associated with the miscellaneous procedures.

40. The method of claim 35 further comprising, after the step of generating, by the computing system, a report providing the correct code, the point value of the medical procedure, and relevant data on the patient, the step of transmitting the report to the third party payer.

41. The method of claim 40 wherein the step of transmitting the report to the third party payer includes encrypting the report.

42. The method of claim 41 further comprising, after the step of transmitting the report to the third party payer, the step of deciphering the encrypted report by the third party payer.

43. The method of claim 35 wherein the correct code is a standardized medical code.

44. The method of claim 43 wherein the standardized medical code is a Current Procedural Terminology (CPT) code.

45. The method of claim 44 wherein the step of determining, by the computing system, the correct code from said selected medical description, includes the step of associating an International Classification of Diseases 9^{th} edition Clinical Modification (ICD9) code associated with the CPT code.

46. A method of defining and reporting accurate medical codes of a patient for medical billing to a third party payer, said method comprising the steps of:
inputting, by an anesthesiologist assisting a surgeon performing a medical procedure on a patient, data on the patient into an input terminal;
providing, by a computing system communicating with the input terminal, a plurality of medical descriptions describing medical procedures;
selecting, by the anesthesiologist, a medical description accurately describing said medical procedure performed on said patient from said plurality of medical descriptions;
determining, by the computing system, the correct code from said selected medical description;
determining, by the computing system, a correct anesthesia code from the correct selected code;
calculating, by the computing system, a point value for the determined correct code; and
generating, by the computing system, a report providing the correct code, the point value of the medical procedure, and relevant data on the patient.

47. The method of claim 46 further comprising, after the step of inputting, by an anesthesiologist assisting a surgeon performing a medical procedure on a patient, data on the patient, the step of querying, by the anesthesiologist, the surgeon on the medical procedure performed on the patient.

48. The method of claim 46 wherein the step of determining, by the computing system, the correct code from said selected medical description includes determining a Current Procedural Terminology (CPT) code.

49. The method of claim 48 wherein the step of determining, by the computing system, a correct anesthesia code from the correct selected code includes determining a CPT anesthesia code from the CPT code.

50. The method of claim 48 wherein the step of determining, by the computing system, the correct code from said selected medical description, includes the step of associating an International Classification of Diseases 9^{th} edition Clinical Modification (ICD9) code associated with the CPT code.

51. The method of claim 46 further comprising, after the step of generating, by the computing system, a report providing the correct code, the point value of the medical procedure, and relevant data on the patient, the step of transmitting the report to the third party payer.

52. The method of claim 51 wherein the step of transmitting the report to the third party payer includes encrypting the report.

53. The method of claim 52 further comprising, after the step of transmitting the report to the third party payer, the step of deciphering the encrypted report by the third party payer.
